(19) United States
(12) Patent Application Publication
(10) Pub. No.: US 2012/0250602 A1
(43) Pub. Date: Oct. 4, 2012

(54) METHOD AND APPARATUS TO IMPROVE HIGH-SPEED MOBILITY IN A WIRELESS COMMUNICATION SYSTEM

(75) Inventors: Meng-Hui Ou, Taipei (TW); Richard Lee-Chee Kuo, Taipei (TW); Yu-Hsuan Guo, Taipei (TW)

(73) Assignee: INNOVATIVE SONIC CORPORATION, Taipei City (TW)

(21) Appl. No.: 13/432,492

(22) Filed: Mar. 28, 2012

Related U.S. Application Data
(60) Provisional application No. 61/468,969, filed on Mar. 29, 2011.

(51) Int. Cl. H04W 36/16; H04W 88/04

(52) U.S. Cl. 370/315

(57) ABSTRACT

A method and apparatus are disclosed to improve high-speed mobility. In one embodiment, the method comprises broadcasting, from a cell, an indication that the cell supports a relay node to access, select or re-select. The method also comprises allowing the relay node to access the cell if there is the indication that the cell supports the relay node, and not allowing the relay node to access the cell if there is no indication that the cell supports the relay node.

### CROSS-REFERENCE TO RELATED APPLICATIONS

The present application claims the benefit of U.S. Provisional Patent Application Ser. No. 61/468,969 filed on Mar. 29, 2011 the entire disclosure of which is incorporated herein by reference.

### FIELD

This disclosure generally relates to wireless communication networks, and more particularly, to a method and apparatus to improve high-speed mobility in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

A method and apparatus are disclosed to improve high-speed mobility. In one embodiment, the method comprises broadcasting, from a cell, an indication that the cell supports a relay node to access, select or re-select. The method also comprises allowing the relay node to access the cell if there is the indication that the cell supports the relay node, and not allowing the relay node to access the cell if there is no indication that the cell supports the relay node.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according exemplary embodiment.

FIG. 4 is a functional block diagram of the program code of FIG. 3 according to one exemplary embodiment.

FIG. 5 is a flow chart according to one exemplary embodiment.

FIG. 6 is a flow chart according to one exemplary embodiment.

FIG. 7 is a flow chart according to one exemplary embodiment.

FIG. 8 is a flow chart according to one exemplary embodiment.

FIG. 9 is a flow chart according one exemplary embodiment.

FIG. 10 is a flow chart according to one exemplary embodiment.

FIG. 11 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including Document Nos. TS 36.331-V10.0.0, “RRC protocol specification (Release 10)”; RP-110398, “New Study Item Proposal: Mobile Relay for EUTRA”; TS 36.300 V10.2.0, “E-UTRA and E-UTRAN; Overall description: Stage 2”; TS 36.423 V10.0.0, “E-UTRAN X2AP (Release 10)”. The standards and documents listed above are hereby expressly incorporated herein.

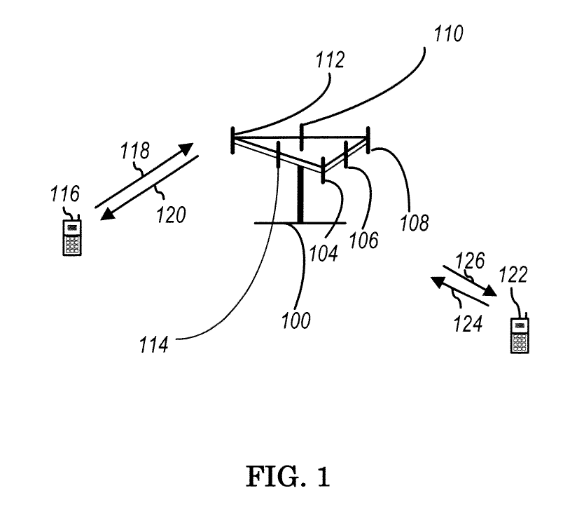

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an eNodeB, or some other terminology. An access terminal (AT) may also be called user equipment (UE) or a relay node (RN), a wireless communication device, terminal, access terminal or some other terminology.

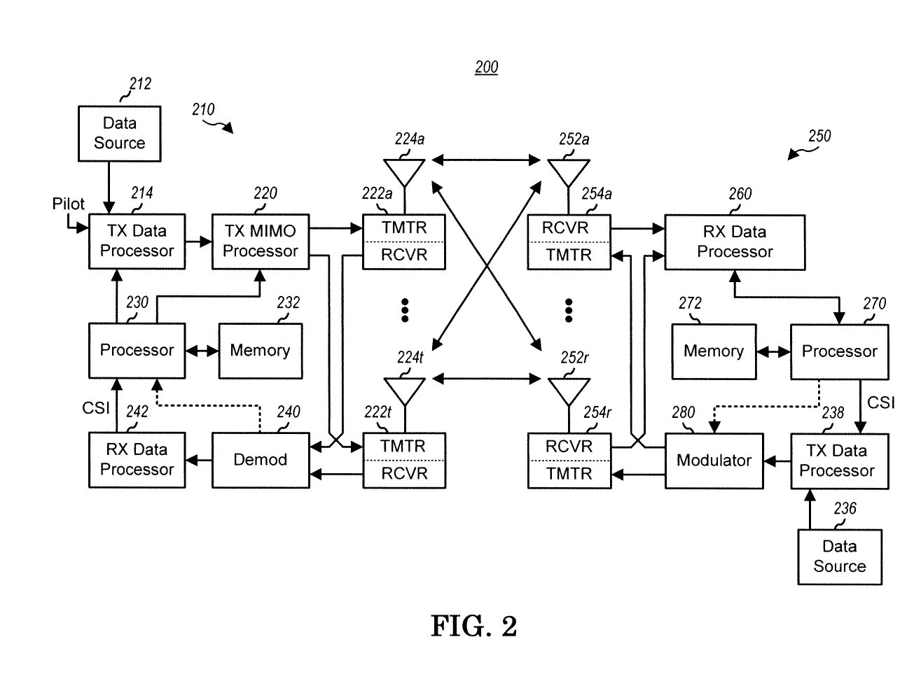

FIG. 2 is a simplified block diagram of an embodiment of a transmitter system 210 (also known as the access network) and a receiver system 250 (also known as access terminal (AT) or user equipment (UE) or relay node (RN)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments. TX MIMO processor 220 applies beamforming weights to the symbols of the data streams and to the antenna from which the symbol is being transmitted.

Each transmitter 222 receives and processes a respective symbol stream provide one or more analog signals, and further conditions (e.g., amplifies, filters, and upconverts) the analog signals to provide a modulated signal suitable for transmission over the MIMO channel, N_{T} modulated signals from transmitters 222a through 222t are then transmitted from N_{T} antennas 224a through 224t, respectively.

At receiver system 250, the transmitted modulated signals are received by N_{R} antennas 251a through 252r and the received signal from each antenna 252 is provided to a respective receiver (RCVR) 254a through 254r. Each receiver 254 conditions (e.g. filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

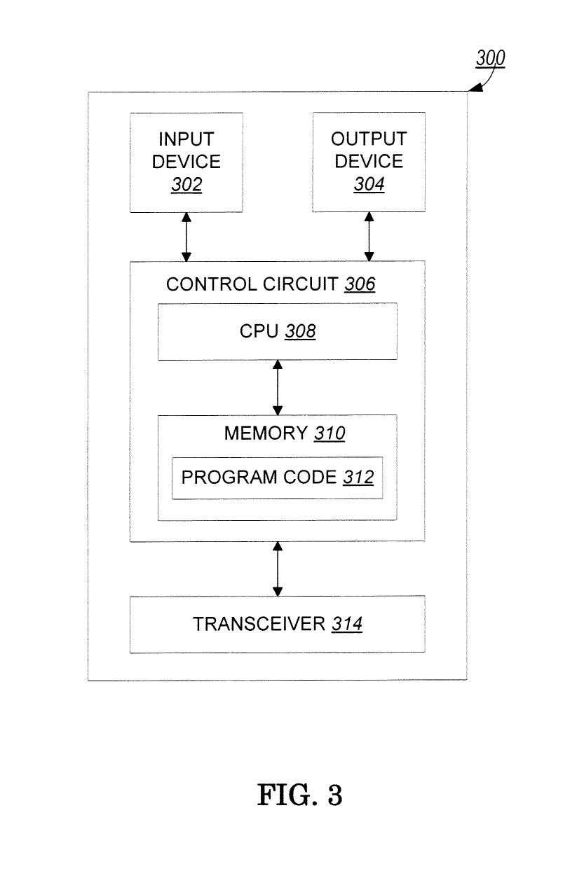

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs or RNs) 116 and 122 in FIG. 1, and the wireless communications system is preferably the LTE-A system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

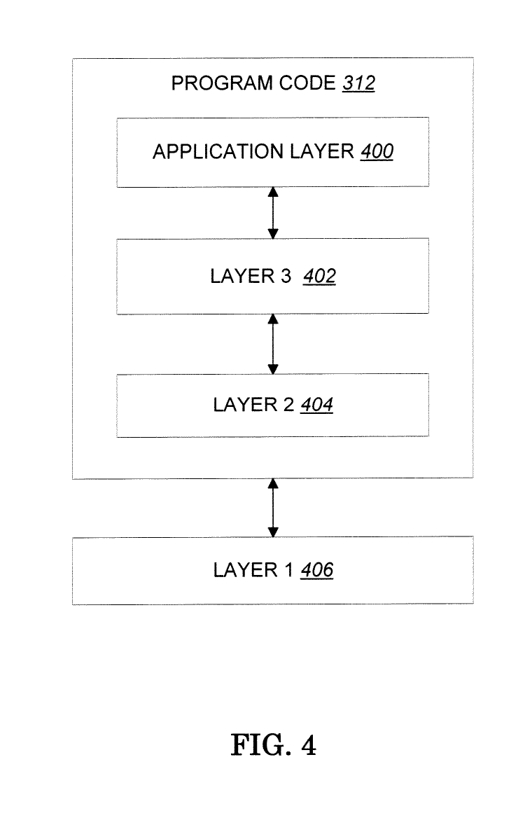

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

3GPP RP-110398 proposes a new Study Item about Mobile Relay for Evolved Universal Terrestrial Radio Access (EUTRA). In general, high speed public transportation is being deployed worldwide at an increased pace. Hence, providing multiple services of good quality to users on high speed vehicles is important. One of the challenges comparing with the typical mobile wireless environments is the reduced handover success rate due to the following reasons: (i) handover occurs much more frequent; (ii) a mass of UEs performing handover at the same time which results in excessive signaling overhead; and (iii) UE measurements in high speed environments are typically less accurate than low speed environments. Mobile relay node a relay node mounted on a vehicle wirelessly connected to the macro cells) is considered to be a potential technique to solve the problem. Information related to a stationary relay node can be found in 3GPP TS 36.331 V10.0.0 and TS 36.300 V10.2.0.

The Relay Node (RN) startup procedure is described in 3GPP TS 36.300 V10.2.0 as follows:

4.7.6.3 RN Startup Procedure
Figure 4.7.6.3-1 shows a simplified version of the startup procedure for the RN. The procedure is based on the normal UE attach procedure [17] and it consists of the following two phases:

I. Phase Attach for RN Preconfiguration.
The relay node attaches to the E-UTRAN/EPC as UE at power-up and retrieves initial configuration parameters, e.g. list of DeNB cells, from RN OAM. After this operation is complete, the relay node detaches from the network as a UE and triggers Phase II. The MME performs the S-GW and P-GW selection for the RN as a normal UE.

II. Phase II: Attach for RN Operation.
The relay node connects to a DeNB selected from the list acquired during Phase I to start relay operations. For this purpose, the normal RN attach procedure described in section 4.7.6.1 is applied. After the DeNB initiates setup of bearer for S1/X2, the RN initiates the setup of S1 and X2 associations with the DeNB (see section 4.7.4). In addition, the DeNB may initiate an RN reconfiguration procedure via RRC signalling for RN-specific parameters.
After the S1 setup, the DeNB performs the S1 eNB Configuration Update procedure(s), if the configuration data for the DeNB is updated due to the RN attach. After the X2 setup, the DeNB performs the X2 eNB Configuration Update procedure(s) to update the cell information. In this phase the RN cells' ECGIs are configured by RN OAM.

As described above, the relay node operates as a UE and retrieves a list of DeNB (Donor evolved Node B) cells that are allowed to access during Phase I of the RN startup procedure. The relay node operates as a relay node and connects to a DeNB during Phase II. Furthermore, as specified in 3GPP TS 36.300 V10.2.0, inter-cell handover is not supported for (stationary) relay nodes.

Comparing with a stationary relay node, a mobile relay node may move and perform mobility procedure when operating as a relay node. Since a mobile relay node may connect to many different cells while moving around, the list of DeNB cells may be much larger. Besides, these cells may be under different RN OAMs (Operation Administration and Maintenance). To provide the complete list of DeNB cells to a mobile relay node, all these RN OAMs need to be coordinated and each of them has to maintain a huge list for the mobile relay node. Another possible drawback is that if a complete list is maintained, a stationary relay node would also receive the huge list (with lots of useless information) because RN OAM does not know whether the relay node is stationary or mobile. Therefore, more efficient method to maintain the list of DeNB cells for a mobile relay node should be studied. To solve the problem, multiple alternative embodiments are discussed below.

In one embodiment, the cell of a DeNB would broadcast an indication as to whether the cell supports the mobile relay functionality. For example, the presence of the indication represents that the cell supports a mobile relay node to access. A mobile relay node would not be allowed to access, select, reselect, or connect to the cell that does not broadcast an indication when the mobile relay node is operating as a relay. With the indication, a mobile relay node would not need to maintain the list of DeNB cells a mobile relay node may not need to perform Phase I).

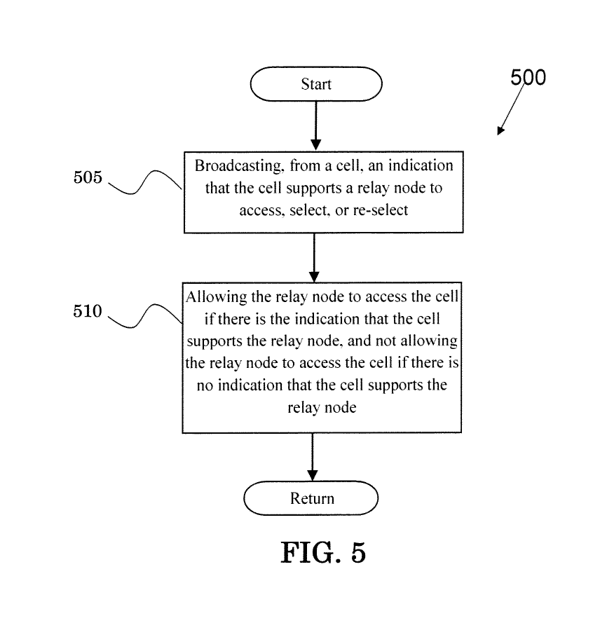

FIG. 5 illustrates a flow chart 500 in accordance with one exemplary embodiment. In step 505, a cell broadcasts an indication that the cell supports a relay node to access, select, or re-select. In step 510, if there is an indication that the cell supports the relay node, the relay node would be allowed to access the cell. Otherwise, if there is no such indication, the relay node would not be allowed to access the cell. In this embodiment, the cells that a mobile relay node is allowed to access could be known with less complexity.

Referring back to FIGS. 3 and 4, an eNB controlling a cell 300 includes a program code 312 stored in memory 310. In one embodiment, the CPU 308 could execute the program code 312 (i) to broadcast, from the cell, an indication that the cell supports a relay node to access, select, or re-select, and (ii) to allow the relay node to access the cell if there is an indication that the cell supports the relay node, and not allow the relay node to access the cell if there is no indication that the cell supports the relay node. In one embodiment, the indication could be a Boolean or the existence of information specifically for relay nodes. The indication could also be broadcasted in the system information (as a SystemInformationBlockType1 or a SystemInformationBlockType2). Furthermore, the relay node could be a mobile relay node or a stationary relay node. In addition, supporting a relay node could mean that a configuration related to a relay node could be provided or a group mobility procedure could be used.

In another embodiment, a mobile relay node provides an indication to the network that it is a mobile relay node. This indication could be used by the network to differentiate whether the relay node is stationary or mobile. For example, the network could decide to give a complete list or a localized list of DeNB cells to the relay node based on the indication. The indication can be provided during Phase I (e.g., before the retrieval of the list of DeNB cells).

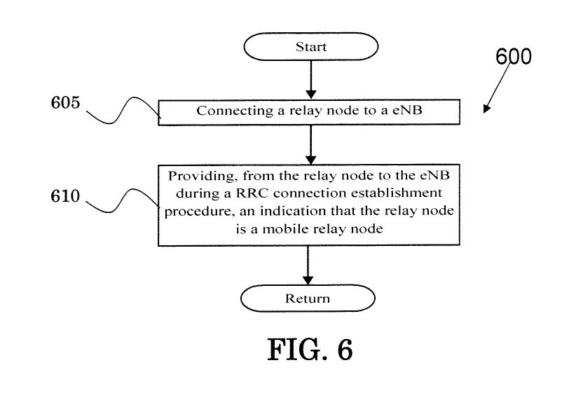

FIG. 6 illustrates a flow chart 600 in accordance with one exemplary embodiment. In step 605, a relay node is connecting to an eNB. In step 610, the relay node provides an indication to the eNB, during a RRC (Radio Resource Control) connection establishment procedure, that the relay node is a mobile relay node. In this embodiment, the cells that a mobile relay node is allowed to access could be known with less complexity.

Referring back to FIGS. 3 and 4, a relay node 300 includes a program code 312 stored in memory 310. In one embodiment, the CPU 308 could execute the program code 312 (i) to connect the relay node to an eNB, and (ii) to provide, from the relay node to the eNB, an indication that the relay node is a mobile relay node. In one embodiment, the indication could be provided during a RRC connection establishment procedure, such as in the RRC Connection Setup Complete message. Furthermore, the indication could be provided in Phase I (described in 3GPP IS 36.300 V10.2.0). The indication could also be provide before the retrieval of the list of DeNB cells which lists the cells that the mobile relay node is allowed to access. In addition, the indication could be an indication whether the relay node is stationary or mobile.

In another embodiment, a (stationary or mobile) relay node would maintain a list of DeNB cells. Furthermore, the relay node would be allowed to access, select, reselect, or connect to the cell not in the list (such as upon connection re-establishment). When a cell not in the listed is chosen, the relay node would update or retrieve the list. For example, the relay node could update or retrieve the list by performing a RN startup procedure from Phase I (described in 3GPP TS 36.300 V10.2.0) when no cell in the list could be found, selected, or re-selected. Furthermore, the relay node may detach after updating or retrieving the list when the connected cell is not in the updated list. Alternatively, the relay node may perform a RN startup procedure from Phase I when a cell currently connected is still not in the list of DeNB cells after the list is updated.

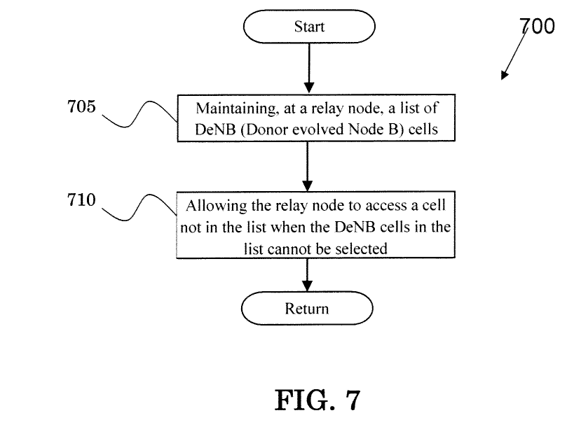

FIG. 7 illustrates a flow chart 700 in accordance with one exemplary embodiment. In step 705, a relay node maintains a list of DeNB cells. In step 710, the relay node is allowed to access (as well as to select or re-select) a DeNB cell not in the list if the DeNB cells in the list cannot be selected. In this embodiment, the cells which a relay node is allowed to access can be known with less complexity. In addition, the duration of relay operation interruption due to re-establishment could be reduced.

Referring back to FIGS. 3 and 4, a relay node 300 includes a program code 312 stored in memory 310. In one embodiment, the CPU 308 could execute the program code 312 (i) to maintain, at the relay node, a list of DeNB cells, and (ii) to allow the relay node to access (as well as to select or re-select) a cell that is not in the list. In one embodiment, the relay node is allowed to access (as well as to select or re-select) a DeNB cell not in the list if the DeNB cells in the list cannot be selected. In addition, the relay node could retrieve a second list of DeNB cells when the cell that is not in the original list is accessed, selected, or re-selected. The relay node could also perform a detach operation if a cell currently connected is not in the second list of DeNB cells after the second list has been retrieved.

In a different embodiment, upon a handover, the target eNB of the mobile (or stationary) relay node could include the list of DeNB cells in the handover command (such as a HandoverCommand message discussed in TS 36.331 V10.0.0 through a HANDOVER REQUEST ACKNOWLEDGE message discussed in TS 36.423 V10.0.0) that is transmitted to the source eNB. The mobile (or stationary) relay node receiving the handover command, e.g., through a RRCConnectionReconfiguration message, could then update or replace the stored list. Furthermore, the target eNB could check whether the source cell is in the list of DeNB cells maintained by the target eNB to decide whether to include the list of DeNB cells in the handover command or not.

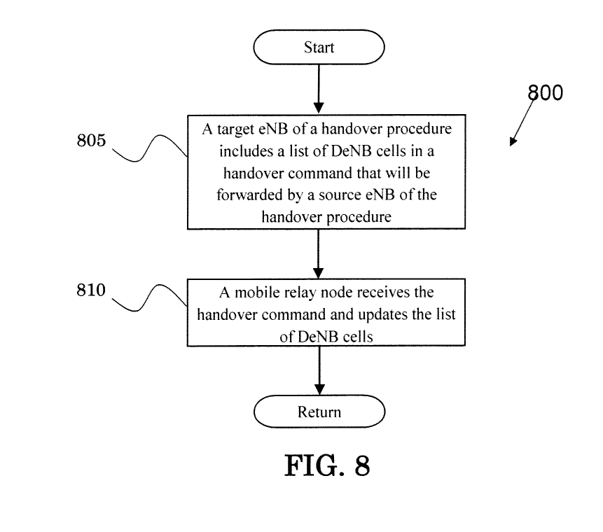

FIG. 8 illustrates a flow chart 800 in accordance with one exemplary embodiment. In step 805, a target eNB would include a list of DeNB cells in a handover command that will be forwarded by a source eNB of a handover procedure. In step 810, a mobile relay node would receive the handover command and would update the list of DeNB cells. In this embodiment, the cells which a mobile relay node is allowed to access can be known with less complexity.

Referring back to FIGS. 3 and 4, a target eNB 300 includes a program code 312 stored in memory 310. In one embodiment, the CPU 308 could execute the program code 312 (i) to include, at the target eNB of a handover procedure, a first list of DeNB cells in a handover command, and (ii) to update, at the mobile relay node, a second list of DeNB cells stored in the relay node. In one embodiment, the handover command could be transmitted from the target eNB to the mobile relay node. In addition, the handover command could be forwarded by a source eNB of the handover procedure.

In another embodiment, the (stationary or mobile) relay node could retrieve or update the list of DeNB cells after handover complete (for example, through an attach for RN preconfiguration in Phase I as described in 3GPP TS 36.300 V10.2.0). Furthermore, the retrieval or update could be triggered when the currently connected cell. i.e. the target cell of the handover, is not in the list of DeNB cells stored and maintained by the relay node. Furthermore, retrieving or updating the list of DeNB cells could be further restricted to the case that the handover was across a specific area, such as a tracking area, a PLMN (Public Land Mobile Network), or a RN OAM.

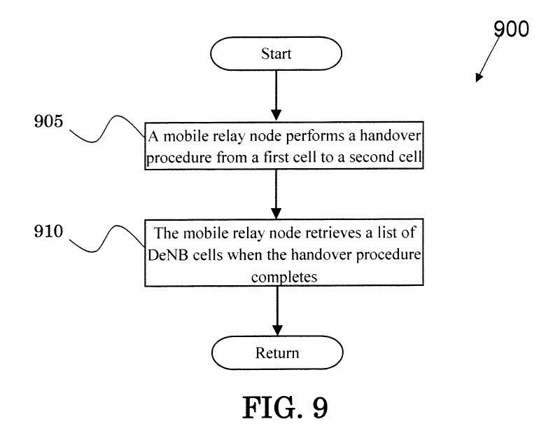

FIG. 9 illustrates a flow chart 900 in accordance with one exemplary embodiment. In step 905, a mobile relay node would perform a handover procedure from a first cell to a second cell. In step 910, the mobile relay node would retrieve a list of DeNB cells when the handover procedure has been completed. In this embodiment, the cells which a mobile relay node is allowed to access can be known with less complexity.

Referring back to FIGS. 3 and 4, a mobile relay node 300 includes a program code 312 stored in memory 310. In one embodiment, the CPU 308 could execute the program code 312 (i) to perform, at the mobile relay node, a handover procedure from a first cell to a second cell, and (ii) to update (or retrieve), at the mobile relay node, a list of DeNB cells when the handover procedure has been completed. In this embodiment the list of DeNB cells is updated if the second cell is not in the list stored in the mobile relay node. Furthermore, the list of DeNB cells could be updated (i) if a tracking area of the second cell is different from a tracking area of the first cell, (ii) if a PLMN (Public Land Mobile Network) of the second is different from a PLMN of the first cell, or (iii) if the RN OAM of the second cell is different from the RN OAM of the first cell.

In addition, to operate, a relay node should connect to a DeNB cell which supports the relay node. When considering a mobile relay node, inter-cell handover is required. For cell selection or re-selection, a relay node could be restricted to select the cell in the list of DeNB cells. As for inter-cell handover, the network should apply similar concept for the eNB that eNB has a list of DeNB cells which a mobile relay node is allowed to access (which may not be the same as the list stored by the relay node), and should prepare to handover the relay node to the target cell that is in the list. However, some complex communication between eNB and RN OAM and some coordination between different RN OAMs would be required if the mobile relay node could move across the cells of different RN OAMs.

In one embodiment, to accomplish an easier handover of a mobile relay node, the source eNB could provide an indication (e.g., in a HANDOVER REQUEST message specified in TS 36.423 V10.0.0 or a HandoverPreparationInformation message specified in TS 36.331 V10.0.0) to the target eNB in the handover preparation phase to indicate that the device which is about to handover is a relay node (or mobile relay node). The target eNB could take the indication into account when deciding whether to accept the handover or not. For example, if the target eNB does not support a mobile relay node, the target eNB could reject the handover request from the source eNB if the request indicates the device about to handover is a mobile relay node.

Alternatively, an indication e.g., in a HANDOVER REQUEST ACKNOWLEDGE message specified in TS 36.423 V10.0.0 or a HandoverCommand message specified in TS 36.331 V10.0.0) could be provided by a second eNB (i.e., the target eNB) to a first eNB (i.e., the source eNB) in the response to the handover preparation (requested by the first eNB). The indication could be used to indicate that the second eNB supports the relay node (or mobile relay node). The eNB supports the relay node may mean that a related configuration (such as rn-SubframeConfig) can be provided or a group mobility procedure can be used. As another alternative, the two indications could be used together. In other words, upon receipt of the indication that the device (which is about to handover) is a relay node, if the second eNB supports the relay node, the second eNB would indicates that it supports the relay node in the response to the handover preparation.

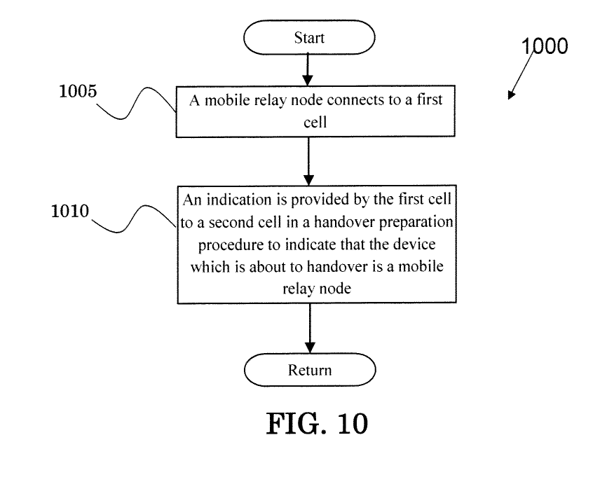

FIG. 10 illustrates a flow chart 1000 in accordance with one exemplary embodiment. In step 1005, a mobile relay node connects to a first cell (e.g., a source cell). In step 1010, the first cell provides an indication to a second cell (e.g., a potential target cell) in a handover preparation procedure to indicate that a device which is about to handover is a mobile relay node. In this embodiment, the first cell is a source cell of the mobile relay node, and the second cell is a potential target cell of the mobile relay node.

Referring back to FIGS. 3 and 4, an eNB controlling a first cell 300 includes a program code 312 stored in memory 310. In one embodiment, the CPU 308 could execute the program code 312 (i) to connect a mobile relay node to the first cell, and (ii) to provide, from the first cell, an indication to a second cell in a handover preparation procedure to indicate that a device about to be handover is a mobile relay node.

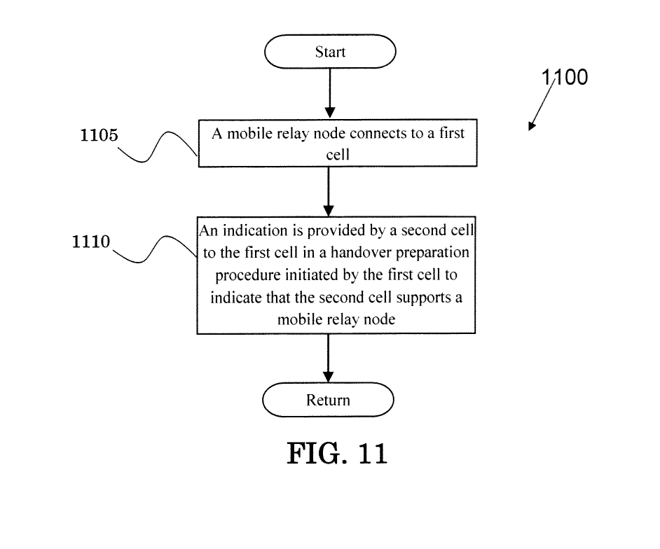

FIG. 11 illustrates a flow chart 1100 in accordance with one exemplary embodiment. In step 1105, a mobile relay node connects to a first cell (e.g., a source cell). In step 1010, a second cell (e.g., a potential target cell) provides an indication to the first cell in a handover preparation procedure initiated by the first cell to indicate that the second cell supports a mobile relay node.

Referring back to FIGS. 3 and 4, an eNB controlling a second cell 300 includes a program code 312 stored in memory 310. In one embodiment, the CPU 308 could execute the program code 312 (i) to connect a mobile relay node to a first cell, and (ii) to provide, from the second cell, an indication to the first cell in a handover preparation procedure to indicate that the second cell supports a mobile relay node. In this embodiment, the first cell is a source cell of the mobile relay node, and the second cell is a potential target cell of the mobile relay node.

In addition, the CPU 308 can execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced, using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method to improve high-speed mobility, comprising:
broadcasting, from a cell, an indication that the cell supports a relay node to access, select or re-select; and
allowing the relay node to access the cell if there is the indication that the cell supports the relay node, and not allowing the relay node to access the cell if there is no indication that the cell supports the relay node.

2. The method of claim 1, wherein the relay node is operating as a relay node.

3. The method of claim 1, wherein the relay node is a mobile relay node.

4. A method to improve high-speed mobility, comprising:
a relay node is connecting to an eNB (evolved Node B); and
providing, from the relay node to the eNB, an indication that the relay node is a mobile relay node.

5. The method of claim 4, wherein the indication is provided during Phase I.

6. The method of claim 4, wherein the indication is provided before retrieval of a list of DeNB (Donor evolved Node B) cells.

7. The method of claim 4, wherein the indication is provided in a RRC (Radio Resource Control) Connection Setup Complete message.

8. A method to improve high-speed mobility, comprising:
maintaining, at a relay node, a first list of DeNB (Donor evolved Node B) cells; and
allowing the relay node to access, select, or re-select a cell that is not in the first list of DeNB cells.

9. The method of claim 8, wherein the relay node is allowed to access, select, or re-select the cell that is not in the first list of DeNB cells when the DeNB cells in the first list cannot be selected.

10. The method of claim 8, wherein the relay node retrieves a second list of DeNB cells when the cell that is not in the first list of DeNB cells is accessed, selected, or re-selected.

11. The method of claim 10, wherein the relay node performs a detach operation if a cell currently connected is not in the second list of DeNB cells after the second list has been retrieved.

12. A method to improve high-speed mobility, comprising:
including, at a target eNB (evolved Node B) of a handover procedure, a first list of DeNB (Donor evolved Node B) cells in a handover command to update, at a mobile relay node, a second list of DeNB cells stored in the relay node.

13. The method of claim 12, wherein the handover command is transmitted from the target eNB to the mobile relay node.

14. The method of claim 12, wherein the handover command is forwarded by a source eNB of the handover procedure.

15. A method to improve high-speed mobility, comprising:
performing, at a mobile relay node, a handover procedure from a first cell to a second cell; and
updating, at the mobile relay node, a list of DeNB Donor evolved Node B) cells when the handover procedure is completed.

16. The method of claim 15, wherein the list of DeNB cells is updated if the second cell is not in the list stored in the mobile relay node.

17. The method of claim 15, wherein the list of DeNB cells is updated if a tracking area of the second cell is different from a tracking area of the first cell.

18. The method of claim 15, wherein the list of DeNB cells is updated if a PLMN (Public Land Mobile Network) of the second cell is different from a PLMN of the first cell.

19. The method of claim 15, wherein the list of DeNB cells is updated if a RN (Relay Node) OAM (Operation Administration and Maintenance) of the second cell is different from a RN OAM of the first cell.

20. A method to improve high-speed mobility, comprising:
having a connection between a first cell and a device which is a mobile relay node; and
providing, from the first cell, an indication to a second cell in a handover preparation procedure to indicate that the device that is about to be handover is the mobile relay node.

21. The method of claim 20, wherein the first cell is a source cell of the mobile relay node.

22. The method of claim 20, wherein the second cell is a potential target cell of the mobile relay node.

23. A method to improve high-speed mobility, comprising:
having a connection between a mobile relay node and a first cell; and
providing, from a second cell, an indication to the first cell in a handover preparation procedure initiated by the first cell to indicate that the second cell supports the mobile relay node.

24. The method of claim 23, wherein the first cell is a source cell of the mobile relay node.

25. The method of claim 23, wherein the second cell is a potential target cell of the mobile relay node.
